(19) United States
(12) Patent Application Publication
(10) Pub. No.: US 2001/0028021 A1
(43) Pub. Date: Oct. 11, 2001

(54) Hose guide

(76) Inventor: Alan Martin, East Sandwich, MA (US)

Correspondence Address: George L. Greenfield, Wolf, Greenfield & Sacks, P.C., 600 Atlantic Avenue, Boston, MA, 02210, US

(21) Appl. No.: 09/766,991

(22) Filed: Jan. 22, 2001

Related U.S. Application Data
(60) Provisional application No. 60/178,436, filed on Jan. 27, 2000.

(51) Int. Cl. B05B 15/06

(52) U.S. Cl. 248/87; 248/75

(57) ABSTRACT

A hose guide having a polygonal frame defining an opening through which the hose extends. All of the sides of the opening carry rollers to enable the hose to be pulled through it. Preferably, the frame also includes a stake which rotatably supports the frame about the stake axis.

### PRIOR APPLICATION

The present application claims the benefit of applicant's earlier filed copending provisional application No. 60/178,436 filed Jan. 27, 2000, entitled HOSE GUIDE.

### FIELD OF THE INVENTION

This invention relates to hose guides and more particularly is directed to a guide for garden hoses and other similar flexible conduits so as to enable them to be drawn from a reel or hanger and pulled in any desired direction without crimping. The guide also enables the hose to be easily retracted onto a reel or hanger.

### BACKGROUND OF THE INVENTION

Anyone who has had any gardening experience is aware of the difficulties in extracting substantial lengths of water hose from reels or hangers. Unless the hose is pulled from the reel or rack generally perpendicular to the axis about which the hose is wound will very easily become crimped or twisted so as to make it more difficult to draw the hose in the desired direction. Furthermore, the crimped and twisted sections of the hose impede the flow of water through it. The crimped and twisted sections also make the task of rewinding the hose on a reel or rack more difficult. A number of different devices intended to prevent hoses from crimping or twisting are shown in the prior art including U.S. Pat. Nos. 1,367,780; 1,831,306; 3,599,917; 3,844,516; 5,224,310 and 5,806,814. None of these devices, however, have proved entirely satisfactory.

One object of the present invention is to provide a hose guide that enables a hose drawn through it to be pulled in any direction without crimping or twisting. Another object of the present invention is to provide a hose guide that provides roller supports for the hose as it is pulled through the guide so as to reduce the forces required to extend the hose through it. Yet another aspect of the present invention is to assist gardeners while extending the hose in any direction and to retract the hose onto a reel or hanger. Other objects of the present invention are to provide a hose guide that may elevate a hose above flowers and other flora to prevent them from being broken or otherwise damaged by the hose as it is moved in a garden, to provide a hose guide that may rotate as well as move up and down to accommodate the direction in which the hose used with the guide is being drawn through it, and to provide a guide that may be used with other like guides in series particularly when a very long hose is being handled.

### SUMMARY OF THE INVENTION

To accomplish these and other objects, the hose guide of the present invention includes a rectangular frame made up of upper and lower horizontal arms and vertical side arms preferably made from pipe although they may be made of solid material as well. A horizontal cross arm is disposed between the upper and lower arms and extends between the side arms. Sleeve rollers are disposed on the upper and horizontal cross arms and similar sleeve rollers are disposed on the side arms between the upper and horizontal cross arms. All of the rollers are freely rotatable on their respective arms of the frame and as they cover the arms on which they are carried, a hose drawn through the area defined by the arms will have very limited frictional contact with the stationary portions of the frame. That opening is sufficiently large so as to enable the hose to be used with a nozzle, handle, spout, valve, or other fixture mounted on the hose to extend through the opening. A post, preferably having an adjustable height, is connected to the lower horizontal arm and serves as a stake for mounting the frame for rotation about the axis of the stake in a lawn, flower bed, or other location convenient for the user.

The invention will be better understood and appreciated from the following detailed description of an embodiment of the invention read in conjunction with the accompanying drawings.

### BRIEF DESCRIPTION OF THE DRAWINGS

FIG. 1 is a perspective view showing a hose guide embodying the present invention with a hose shown in broken lines extending through the guide;

FIG. 2 is an enlarged front elevation view partially broken away, of the hose guide and hose shown in FIG. 1;

FIG. 3 is a fragmentary cross-sectional view of the guide and also suggesting the hose, taken along the section line 3-3 in FIG. 2 and;

FIGS. 4 and 5 are fragmentary views of alternative embodiments of the base of the guide.

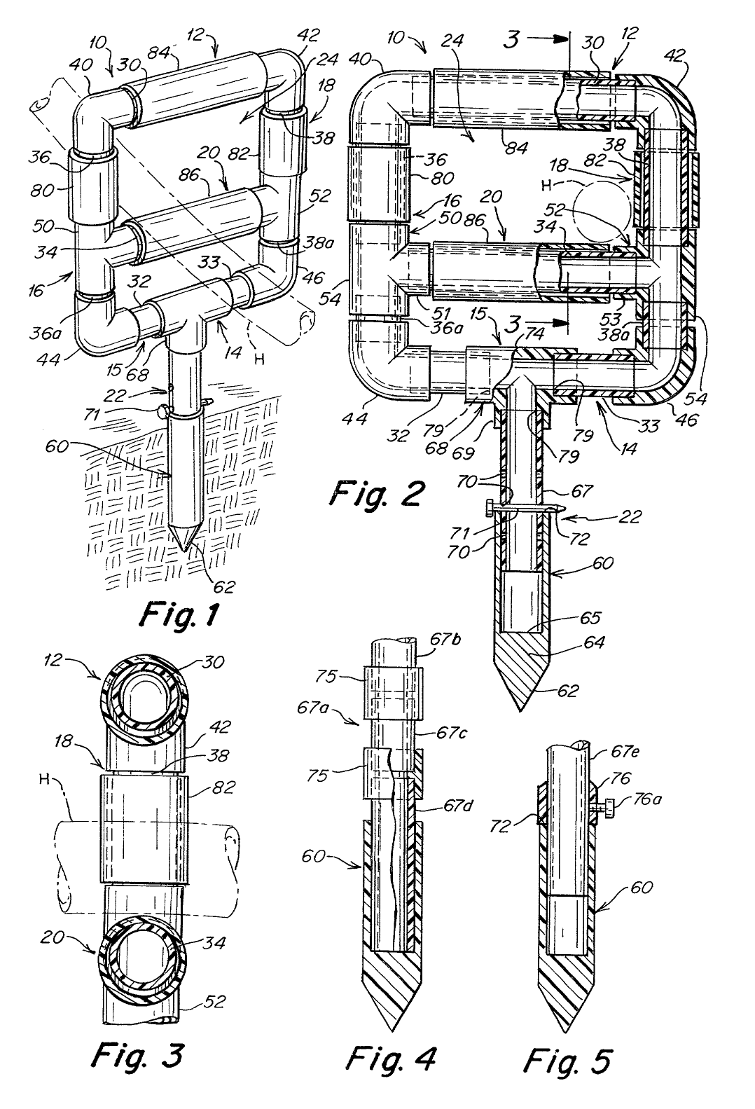

### DETAILED DESCRIPTION

The hose guide of the present invention is made up of a number of pipes, elbows, tees and rollers that together are assembled to form a rectangular body 10 having upper and lower horizontal arms 12 and 14, left and right vertical side arms 16 and 18, intermediate horizontal cross arm 20 and base assembly 22. The spatial orientation of the various members, that is, the horizontal and vertical arms is of course, a function of the orientation of how the base assembly 22 is inserted in the ground. If it is vertical, the spatial relationships recited are accurate, but of course, if the base is not oriented vertically in the ground, the arms will not necessarily be horizontal and vertical as described. In the preferred embodiment shown, the rectangular body is approximately eight inches high and nine inches wide, but it should be appreciated that the size is not a limiting feature, but rather is dictated by the diameter of the hose, conduit or other flexible material such as cable with which it is to be used. In the embodiment shown the frame includes an upper rectangular opening 24 defined by the horizontal arms 12 and 20 and the left and right side arms 16 and 18 and through which the hose H shown in broken lines, extends. The bottom portion 15 of the frame 10 below the horizontal cross arm 20 imparts stiffness and stability to the frame but ordinarily is not used as a guide for the hose.

The frame 10 includes an upper horizontal pipe 30, coaxial lower pipes 32 and 33, and an intermediate horizontal pipe 34. The frame also includes left and right upper side vertical pipes 36 and 38 and left and right lower side vertical pipes 36a and 38a. The upper horizontal pipe 30 is connected to the left side upper vertical pipe 36 by elbow 40 and the other end of the upper horizontal pipe 30 is connected to the right side upper vertical pipe 38 by means of elbow 42. Similar elbows 44 and 46 connect the outer ends of the lower horizontal pipes 32 and 33 to the lower side vertical pipes 36a and 38b, respectively.

The intermediate pipe 34 is connected at its ends to the frame by tees 50 and 52. The stems 51 and 53 of the tees 50 and 52 are secured to the ends of the intermediate horizontal pipe 34, and the cross members 54 of the tees 50 and 52 receive the vertical side pipes 36, 36a and 38, 38a. The tees 50 and 52 may be connected to the pipe 34 in the same manner that the pipes 30, 32 and 33 are connected to the elbows 40, 42, 44 and 46. The inner ends of the lower horizontal pipes 32 and 33 are connected to the cross member 74 of the lower tee 68.

While a particular embodiment of the frame 10 is described in detail above, made up of pipes, elbows and tees, it should be appreciated that the frame 10 may be made of fewer or a greater number of segments, and that the opening 24 for the hose although shown and described as being of rectangular, may be triangular or other polygonal shape.

It will be noted particularly in FIG. 2 that the base 22 of the hose guide assembly includes a ground pipe or stake 60 having a pointed lower end 62 that enables the pipe to be driven into the ground. In the embodiment shown, the bottom end of the stake 60 is plugged as suggested at 64 with an upper surface 65 that limits the depth in which vertical pipe 67 carried by the stem 69 of the base tee 68 may extend into it. The vertical pipe 67, preferably rotatable in the stake, has a number of horizontal holes 70 that will receive a pin 71 or other transverse member that may rest upon the upper end 72 of the ground pipe 60 so as to afford a height adjustment of the hose guide. In FIG. 2 this is shown in detail. Note that the pin 71 extends through the middle of the three holes 70 in the vertical pipe 67 and rests on the top 72 of the stake 60, thereby elevating the frame above the position it would occupy if the pipe 67 rested on the surface 65 of plug 64 without interfering with its rotation. Other elevated positions may be achieved with the pin 71 disposed in one of the other holes 70 in the vertical pipe 67.

It should be appreciated that height adjustment may be achieved in other ways as suggested in FIGS. 4 and 5. In the arrangement shown in FIG. 4 the vertical pipe 67a is made up of several short sections 67b, 67c and 67d joined together by couplers 75. The bottom vertical pipe section may rest on the surface 65 of the stake 60 and the number of pipe sections 67b . . . n used will determine the elevation of the body 10 above the ground. In FIG. 5 a collar 76 adjustably attached to the vertical pipe 67e by means of set screw 76a rests on the top end 72 of the stake 60 to limit the depth of penetration of the vertical pipe in it. The elevation of the body may be varied by changing the position of the collar 76 on the vertical pipe.

It is a desirable feature of the present invention that the vertical pipe 67 connected to the base tee 68 be freely rotatable in or on the stake 60 so as to permit the guide to move through a great number of degrees, preferably 360° and maximize the freedom of direction in which the hose may be pulled through the guide.

In the preferred embodiment, sleeve rollers 80 and 82 are provided on the left and right upper vertical side pipes 36 and 38 and additional horizontal sleeve rollers 84 and 86 are provided on the upper horizontal pipe 30 and intermediate pipe 34. The sleeve rollers are free to turn on the pipes and greatly facilitate the movement of the hose through the opening 24. It will be appreciated that as the hose is being drawn through the opening 24, depending upon the direction in which it is being pulled, it may engage one or more of the sleeve rollers so as to essentially eliminate any frictional contact that would cause wear on the hose as it is drawn through the guide. The sleeve rollers may be made of a plastic material such as #40 PVC or similar material and their inner diameters are substantially larger than the outer diameter of the pipes that carry them to allow the rollers to rotate freely on the pipes. This loose fit of the rollers on the pipes should prevent any debris that lodges between the rollers and pipes from interfering with the rolling action of the rollers. The loose fit also permits some wobbling motion of the rollers, that will dislodge the debris from within them.

While in the embodiment illustrated, the sleeve rollers define a rectangular support for the hose. It should be appreciated that if the frame takes shapes other than that shown, a smaller or greater number of rollers may be used about the hose opening 24. For example, the opening defined by the frame may be of hexagonal configuration and six separate segments of sleeve rollers may be used about the hexagonal opening so as to form a continuous rolling support for the hose. In order to maximize the assistance provided by the hose guide, the sleeve segments should be close enough together so that the hose avoids any significant contact with the fixed piping on which the rollers are mounted.

The pipes, sleeves, tees and elbows typically may be made of plastic such as #40 PVC, but other materials may be used as well. The pipes 30, 32, 33, 34, 36, 36a, 38 and 38a typically may be ½ inch in diameter (outer) while the elbows and tees have a similar inner diameter to receive the pipes. Moreover, the pipes may be fastened to the elbows either by means of threads provided in the ends of each and/or by cementing the various parts of the frame 10 together. A tight friction fit may also be used, that would allow the frame to be disassembled for shipment and storage. The connection of the various pipes, elbows, etc. need not be water tight, but rather only must be sufficiently strong structurally so as to withstand the various forces that are applied to it as the hose is drawn through the frame opening 24.

In FIG. 2 the open ends of the tee 68 are shown to include internal shoulders 79 to limit the depth to which the various pipe sections 32, 33 and 67 may be inserted in the tee. Similar shoulders are present in the open ends of the other tees 50 and 52 as well as the elbows 40, 42, 44 and 46 to orient the pipes that fit into them in the proper position to establish the desired size and shape for the guide. In the embodiment shown the ends of the elbows 40 and 42 the ends of the stems 51 and 53 and the upper ends of the cross members 54 of the tees 50 and 52 serve to retain the rollers on their respective pipes.

The stake 60 may be made of the same material as the pipes in the frame 10 or alternatively from a heavier material such as iron or steel. The plug 64 at the bottom of the stake 60 not only provides a platform for the lower end of the vertical pipe 67, but also closes the lower end of the stake 60 to prevent earth from collecting in it. The stake must provide a rigid stand for the hose guide. Because the hose guide is simply inserted in the stake 60, the guide may readily be removed for storage while the stake remains in the ground. It should also be appreciate that the stake 60 may be made in different lengths so as to elevate or lower the guide.

From the foregoing description, it will be appreciated that a hose or other conduit to be used with the guide may be pulled through the guide in any direction and whatever side of the hose opening 24 is engaged by the hose will allow the hose to be pulled with essentially no frictional resistance as the hose moves through the guide. The hose may enter the opening from virtually any direction with respect to the plain of the hose opening in the guide and the hose may leave the guide in any direction without limit created by the direction in which the hose enters it. The rollers on all sides of the hose opening essentially eliminate frictional contact with the guide and the ability of the guide itself to rotate about the axis of the stake increases the versatility of the guide. The guide is also free to move up and down in the stake 60 limited only by the lowest setting established by the pin 71 in the embodiment of FIG. 2 or set screw 76a and collar 76 of the embodiment of FIG. 5. In the embodiment of FIG. 4 the lowest setting is established by pipe section 67d resting on the bottom of the stake. Furthermore the adjustment provided by each embodiment enables the user to set the guide at a height so as not to damage any surrounding flora either by the guide itself or by the hose used with it. It should also be appreciated that the guide of the present invention may be used together with other like guides when particularly long sections of hose are employed or if it is desired to have the hose span an area above the ground.

It will be appreciated by those skilled in the art that numerous modifications may be made of the present invention without departing from its spirit. Therefore, it is not intended that the breadth of the invention be limited to the specific embodiments illustrated and described. Rather, its breadth is limited only by the appended claims and their equivalents.

What is claimed is:

1. A hose guide comprising
a rectangular frame including upper and lower horizontal arms and vertical side arms, said arms being formed of pipe,
a horizontal cross arm disposed between the upper and lower horizontal arms and connected to the vertical side arms,
said upper arm and cross arm and said vertical arms defining an opening for a hose to pass through the guide,
sleeve rollers carried on the upper arm and cross arm and on the vertical arms between the upper arm and cross arm freely turnable on the arms for enabling a hose to be readily drawn through said opening and minimizing frictional contact with the frame,,
and a base for rotatably supporting the frame in a substantially vertical plane with the frame free to turn about a vertical axis.

2. A hose guide comprising
a peripheral frame having an opening therethrough, said opening being sized to permit a hose to extend freely therethrough, and roller means carried by said frame about all of the sides of the opening for enabling the hose to be pulled easily through the opening and move freely on the roller means when the hose engages the margins of the opening.

3. A hose guide as defined in claim 2 wherein a base supports said frame in a plane extending upwardly from the ground and enables said frame to pivot about the base.

4. A hose guide as defined in claim 3 wherein the base support includes a stake for inserting into the ground and a mounting pipe on the frame that connects to the stake.

5. A hose guide as defined in claim 2 wherein the frame includes plastic pipes and elbows.

6. A hose guide comprising
a frame having an opening therethrough defined by straight sides, said opening being sized to permit a hose to extend freely therethrough, and
roller means carried by each of said sides for enabling a hose to be pulled through the opening and roll freely on the roller means when the hose engages any of the sides of the opening.

7. A hose guide as defined in claim 1 wherein the sleeve rollers have substantial clearance on the arms enabling the rollers to turn freely on the arms and wobble on them.

8. A hose guide as defined in claim 6 wherein the roller means have substantial clearance with respect to the frame so that the roller means turn freely in place and can wobble on the frame.

9. A hose guide comprising
a generally polygonal frame defined by straight, non-rotatable segments for receiving a hose therethrough,
rollers on each of the straight segments of the frame for shielding contact of the hose with the non-rotatable segments for facilitating drawing of the hose through the frame,
and a base for supporting the frame.

10. A hose guide as defined in claim 9 wherein the base includes a stake to be driven into the ground.

11. A hose guide as defined in claim 9 wherein the base is adjustable in height for raising or lowering the frame.

12. A hose guide as defined in claim 10 wherein the base is adjustable in height for raising or lowering the frame.

13. A hose guide as defined in claim 9 wherein frame includes a plurality of pipes, elbows and tees to form the polygonal shape, and the rollers are disposed over the pipes.

14. A hose guide as defined in claim 13 wherein the base includes a stake and mounting pipe adjustably connected together to vary the height of the frame above the ground.

15. A hose guide as defined in claim 14 wherein the frame is rotatable on the stake.
